(19) United States
(12) Patent Application Publication
(10) Pub. No.: US 2023/0228612 A1
(43) Pub. Date: Jul. 20, 2023

(54) LEVEL GAUGE AND METHOD FOR SENSING MATERIAL LEVELS IN TANKS

(71) Applicant: Larry Elvert Carter, Greeley, CO (US)

(72) Inventor: Larry Elvert Carter, Greeley, CO (US)

(21) Appl. No.: 17/577,424

(22) Filed: Jan. 18, 2022

(51) Int. Cl. G01F 23/284; G01F 23/263; G01S 13/88; G01S 13/10

(52) U.S. Cl. CPC G01F 23/284; G01F 23/268; G01S 13/88; G01S 13/103

(57) ABSTRACT

A guided wave level gauge which processes reflections from impedance transitions seen along a probe connected to the gauge. Determines the level based on reflections received from a surface of the material, end of the probe, a connection of the probe to the gauge, and a relative velocity (Vr) of propagation of the electromagnetic signal for the portion of the probe above the material surface to the portion of the probe below the surface. Determines the level without a surface reflection based on the end of probe reflection, probe to gauge connection reflection, relative velocity Vr, and an electrical length of the probe. The methods include determining the relative velocity Vr and the electrical length of the probe. The apparatus includes placing the probe on the outside surface of the tank. The apparatus includes jacketing the probe to improve the reflection received from the end of the probe.

### RELATED APPLICATIONS

The present application claims priority to and the benefit of No. 63/144,131, filed on Feb. 1, 2021, the contents of which are hereby incorporated by reference in its entirety.

### FIELD OF THE INVENTION

The present invention relates generally to level detectors and more specifically to a guided wave level gauge.

### BACKGROUND OF THE INVENTION

The vast majority of recreation vehicle (RV) holding tank level gauge systems use conductance probes. The conductance probes are a type of level switch that indicate whether the probe is wet or dry. These probes penetrate the side of the storage tank at discrete levels. Typically, three or four probes are used plus a reference probe providing at best ¼, ½, ¾ and full indications of the liquid level in the tank. This technology does have limited success in freshwater tanks but is prone to failure in tanks that have debris such as food waste and toilet waste. The debris can insolate the probe from making electrical contact with the liquid in the tank causing the system not to detect the liquid when the liquid's level is at or above the probe's height or may create a conductive path thus causing the level gauge to indicate the liquid level is at the probe's height independent of where the liquid level may actually be.

Another limitation of the conductance point level switch system is the crude resolution of the reported level, for example, there is a large difference in the usability of a tank that is ¾ filled and one that is a few ounces short of being full, yet the level gauges indication is the same, in this case ¾.

Fraser, in Canada Patent 2,285,771 discloses using capacitive plates stacked vertically along the outside of the tank to form the gauge. These gauges have success against the fouling issue experienced by the conductance system but do have some performance limitations. The gauge may only be shortened during installation in a attempt to match the tank height by removing an entire capacitive plate. Depending on the size of each capacitive plate the adjusted gauge may be significantly shorter than the overall tank height. Depending how the gauge is aligned on the tank, either a portion of the top or bottom (or both) of the tank may be left unmonitored.

Other level measurement technologies such as time domain reflectometer (TDR) gauges, often referred to as guided wave radar, and ultrasonic gauges have not been successful in the RV holding tank application because they both penetrate the tank and are prone to fouling. Both ultrasonic and TDR gauges need access to the top of the tank for installation and maintenance. In RV's, the typical holding tank is installed under the floor of the living space and the top of the tank is not accessible. Both ultrasonic and TDR send signals from the top of the tank to the liquid surface and measure the return time of the reflection off of the surface. Ultrasonic sensors fail to detect the surface reflection when foam is present.

Another aspect of the TDR gauge is cost. Electromagnetic signals travel on the probe at speeds approaching the speed of light. Very accurate timing circuits are required to capture the reflected signal and translate it to distance. Expensive components, control loop circuits and temperature compensation circuits are required to control the timing circuits and may require calibration during manufacturing.

U.S. Pat. No. 7,924,216 discloses using reference impedance transitions along the probe at known positions to improve the reliability of determining the filling level. The impedance transitions may be above or below the surface of the material in the tank. The use of these transitions requires an accurate timing circuit and knowledge of the propagation speed of the signal along the probe to translate the reflections into physical distances. To use the transitions below the surface, properties of the material that affect the propagation speed of the signal along the probe must be known or measured. To measure the propagation speed of the material, requires multiple impedance transitions below the surface at known physical distances or requires knowing physical distance to the impedance transition and the physical distance to the surface of the material in the tank. Measuring the physical distance to the surface of the material requires knowing the speed of propagation along the probe above the material surface as well as accurate timing circuits to translate the electrical position of the surface reflection to physical distance. Debris such as toilet paper may collect on the reflectors affecting accuracy and ability to detect the impedance transitions. Since the propagation speed along the probe above the surface needs to be known, unknown materials such as the sidewall of a tank can not come in contact with the probe. Installation of these gauges requires a skill installer that calibrates the gauge to the installation parameters such as probe dimensions, material characteristics and must communicate these parameters to the gauge. This communication requirement adds cost and complexity in the form of displays and buttons or communication interface circuitry as well as adding to installation costs, potential for errors, and installer training. These requirements make TDR gauges too expensive for cost sensitive applications.

Another gauge type in use is capacitive plate gauge where large plates are attached to the outside of the tank and the capacitance formed by the plates, tank walls, and the liquid in the tank is measured. The size of the plates may vary with the tank wall material and thickness. The gauge must be calibrated by empting the tank and communicating that to the gauge and then filling the tank and communicating that to the gauge. Filling the RV holding tanks to the full level is prone to overfilling the tank and having a spill, or under filling the tank and not have a proper calibration. For the RV manufacturer, the time required to fill the tanks and perform the calibration is an added expense.

All of the above issues are also true for marine and industrial applications such as holding tanks in boats, sumps used to gather industrial waste, and tanks holding industrial products.

### SUMMARY OF THE INVENTION

In view of the above-mentioned and other drawbacks of the prior art, a general object of the present invention is to provide an improved level gauge and method.

According to a first aspect of the present invention, these and other advantages are achieved through a level gauge system, for determining a level of a material contained in a tank, comprising: a transceiver for generating, transmitting and receiving electromagnetic signals; a probe electrically connected to the transceiver configured to extend towards and beyond a surface of the material for guiding the signals toward the surface of the material, and guiding reflections from impedance transitions encountered by the signals back to the transceiver; and a processor configured to determine the level of material based on: reflections including at least an end-of-probe reflection from the impedance transition at the end of the probe, a surface reflection from the impedance transition at the surface of the material, and a probe-to-transceiver reflection from the impedance transition of the probe to the transceiver connection, and a relative velocity based on a velocity of propagation of the electromagnetic signals in the portion of the probe above the surface of the material and a velocity of propagation of the electromagnetic signals in the portion of the probe below the surface of the material.

By “relative velocity” should, in context of the present application, at least be understood that the velocity of propagation of the signals along the probe is different depending on objects near the probe. For example, the velocity of propagation of the signals above the material surface may be influenced by a coating on the probe, a tank wall, and a surrounding atmosphere. The velocity of propagation of the probe below the surface may be influenced by the coating on the probe, the tank wall, the atmosphere as well as the material in the tank. The dielectric constant of the material in the tank is higher than the dielectric constant of the atmosphere resulting in a lower velocity of propagation in the portion of the probe below the surface of the material. The relative velocity may be expressed as a ratio of the velocity of the signals below the surface to the velocity of the signals above the surface.

According to some embodiments, the relative velocity may be determined or updated by using a first set of reflections determined at a first level of material in the tank in combination with a second set of reflections taken at a second level which is at a different level of material in the tank than the first level. Both sets of reflection include at least: the connection-to-transceiver reflection, the surface reflection, and the end-of-probe reflection.

According to some embodiments, the risk of fouling the probe as mentioned in the Background section may be eliminated by attaching the probe to an outside surface of a wall of a non-metallic tank in a generally vertical direction configured to propagate the signals starting from the top of the probe and along the probe downward toward the surface of the material.

According to another embodiment, the probe is attached to an outside surface of a wall of a non-metallic tank in a generally vertical direction configured to propagate the signals from the bottom of the probe and along the probe upward toward the surface of the material.

According to another embodiment, the probe may be jacketed with a non-conductive material configured to improve the transmittance of the signals past the material surface and on to the end of the probe so as to improve the detection of the end-of-probe reflection.

According to some embodiments, the level may be determined without the use of the surface reflection by configuring the processor to determine the level based on: the probe-to-transceiver reflection, the end-of-probe reflection, the relative velocity, and a previously determined electrical length of the probe. Furthermore, the level determined from the above reflections can improve the reliability of the level measurement by determining the electrical position of the surface reflection to aid in detecting the surface reflection for use as described above in the first aspect.

In context of the present application, the term “electrical position” should at least be understood to be the position in time of a reflection at the output of a receiver side of the transceiver relative to a start time of a process such as generating the electromagnetic signals. In some embodiments, an analog-to-digital (A/D) converter samples the output of the receiver at a periodic rate and stores the samples in an array, and the electrical position of a reflection is the position of the reflection in the array.

In context of the present application, the term “electrical length” should at least be understood to be the difference in time between two reflections at the output of the receiver side of the transceiver. In some embodiments, an analog-to-digital (A/D) converter samples the output of the receiver at a periodic rate and stores the samples in an array, and the electrical length is the difference between the indexes of the two reflections in the array.

According to some embodiments, the processor determines the electrical length of the probe when the tank is empty of the material based on the probe-to-transceiver reflection and the end-of-probe reflection.

According to some embodiments, the processor can determine the electrical length of the probe when the tank is partially filled based on the probe-to-transceiver reflection, the surface reflection, the end-of-probe reflection, and the relative velocity.

According to some embodiments, a cost advantage can be achieved over other systems described in the Background section by using low cost timing circuitry that has little or no temperature compensation. The use of the low cost timing circuitry has no impact on the level measurement described above in the first aspect. However, the electrical length of the probe or the first set of reflections used in determining the relative velocity may have been determined from past reflections while at a different ambient temperature than the present ambient temperature. The solution is to place a delay line between a signal generation and receiving circuitry of the transducer and the probe connection to the transceiver. The delay line separates, in time, a direct feedthrough signal, from the transmitting side of the transceiver to the receiving side of the transceiver, from the reflection of the probe-to-transceiver reflection. A correction ratio can be determined based on the relative electrical length of the feedthrough signal to the probe-to-transceiver reflection from both the past reflections and the present reflections. This correction ratio can be applied to either set of reflections, past or present, to have a common timing base between both sets of reflections.

According to some embodiments, the correction ratio can also be applied to a reference reflection curve that is used to improve detection of the surface reflection and the end-of-probe reflection. The correction ratio could be used to resample the reference reflection curve prior to using the curve in a detection process.

According to some embodiments, the advantages are achieved through a method of determining a level of material contained in a tank, the method comprising generating and transmitting electromagnetic signals; propagating the electromagnetic signals toward a surface of the material contained in the tank along a probe extending towards and beyond the surface; receiving a first-set of reflections resulting from reflections at impedance transitions encountered by the transmitted electromagnetic signals along the probe, including at least a connection reflection resulting from a reflection caused by a connection of the probe to a transceiver that generates, transmits and receives said electromagnetic signals, a surface reflection resulting from a reflection at the surface of the material, an end-of-probe reflection resulting from a reflection at a end of the probe, and a feedthrough signal resulting from an intersection of a transmitter side of the transceiver and a receiving side of the transceiver.

The method further comprises: determining if the surface reflection is detectable based on the first-set of reflections; if the surface reflection is detectable, determining a level and an electrical length of the probe based on the first-set of reflections and a relative velocity of propagation of the electromagnetic signals along the probe for portions of the probe above the surface of the material relative to a velocity of propagation of the electromagnetic signals along the probe for portions of the probe below the surface.

If the surface reflection is not detectable, the method further determines if the first-set of reflections is the first received after the probe has been installed on the tank based on the end-of-probe reflection; if the first set of reflections is the first received after installation, determining an electrical length of the probe and determining the level based on the connection reflection and end-of-probe reflection; and if the first set of reflections is not the first received after installation, determining a level based on the connection reflection, end-of-probe reflection, and electrical length of the probe and the relative velocity.

The method described in the previous paragraph is useful when the gauge is installed on an empty tank which can be determined by the lack of a surface echo. The electrical length of the probe when installed will be different from the electrical length of the probe when manufactured since the probe is cut to length to match the height of the tank during installation. The new electrical length is determined and stored.

The method further comprises receiving at least a second-set of reflections resulting from reflections at impedance transitions encountered by the transmitted electromagnetic signals and determining an update relative velocity based on the first-set of reflections and the second-set of reflections.

The method further comprises modifying one at least one of the sets of reflections used to determine the relative velocity based on a time of reception of the feedthrough signals and the connection reflections from both sets of reflections.

The method further determines if the electromagnetic signals are propagating downward toward the surface of the material or upward toward the surface of the material based on a polarity of the surface reflection.

### Advantages

Some of the advantages of the present invention are: the gauge provides high resolution measurement over the entire desired measurement region of a tank; the level gauge is cost effective by using low cost timing circuits; and the level gauge is resistant to fouling from the contents of the tank such as solids, paper, and foam since it may be installed on the outside surface of the tank; the level gauge may be installed by a person without professional or specialized knowledge which enables retail, after market, sales of the gauge; the gauge does not need to have an input function to receive calibrated or configured data at the time of installation, which reduces cost, complexity, and the potential for errors; the probe may be cut to length to fit the tank without inputting the new length to the gauge; the gauge does not need to be calibrated with an empty or full tank or any other known level after installation.

### BRIEF DESCRIPTION OF THE DRAWINGS

The detailed description refers to the accompany figures, wherein:

FIG. 1 schematically illustrates a level gauge system with a probe attached to the outside wall of a tank.

FIG. 2 schematically illustrates a simplified block diagram of a level gauge system.

FIG. 3 illustrates an exemplary reflection curve acquired using the level gauge in FIG. 1.

FIG. 4 illustrates a reflection curve acquired with the material level at 50%.

FIG. 5a illustrates a reflection curve acquired with the material at the first level.

FIG. 5b illustrates a reflection curve acquired with the material at the second level.

FIG. 6a schematically illustrates a level gauge system with a probe attached to an outside wall of a tank and the gauge electronics attached at the lower end of the probe.

FIG. 6b illustrates a reflection curve acquired using the level gauge in FIG. 6a.

FIG. 7 schematically illustrates a level gauge system with a jacketed probe.

FIG. 8 is a flow chart for the method of determining the level of material in a tank.

FIG. 9 is a flow chart for determining and updating a relative velocity of propagation of a signal along the probe for portions of the probe above the material surface to the velocity of propagation of the signal for portions of the probe below the material surface.

### DETAILED DESCRIPTION

In the present detailed description, various embodiments of the level gauge are discussed with reference to liquid in a tank. It should be noted that this by no means limits the scope of the present invention, which is equally applicable to measuring other substances in the tank such as grains, pellets, powders, etc.

Moreover, various embodiments of the level gauge illustrate transmitting and receiving electromagnetic pulse signals along a probe. It should be noted that this by no means limits the scope of the present invention, which is equally applicable to utilizing forms of electromagnetic signals such as bursts of high frequency signals and frequency-modulated continuous wave (FMCW).

Moreover, reference is mainly made of a single probe in the form of a wire. As is, however, evident to a person skilled in the relevant art, the probe may be in the form such as a rod, metallic tape, metallic foil, bare wire, jacketed wire, twin lead, etc.

Moreover, various embodiments describe the probe extending from the top to the bottom or from the bottom to the top of a tank. As is, however, evident to a person skilled in the relevant art, the top or bottom of the probe may be position at locations such as the maximum or minimum fill height of a liquid; height where pumps or valves are to be activated or deactivated; heights where alarms are to be activated; etc.

Furthermore, various embodiments use the term “signal velocity” to mean the velocity of propagation of a electromagnetic signal along the probe.

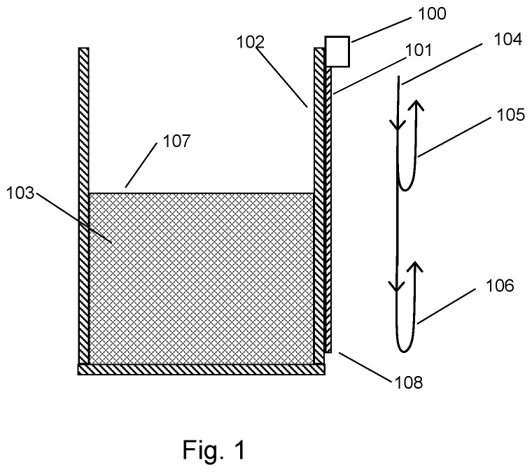

FIG. 1 illustrates the first embodiment where a gauge electronics unit 100 is connected to the upper most point of a probe 101. The probe 101 is in contact with the outside surface of a tank 102 and is positioned in a generally vertical direction. The tank 102 is partially filled with a material 103 having a surface 107. The probe 101 propagates an electromagnetic signal 104 as illustrated from the gauge electronics unit 100 along the probe toward the end of the probe 108. When the electromagnetic signal encounters an impedance discontinuity caused by the surface 107, a reflection 105 is returned to the gauge 100 where a surface reflection is received. A portion of the electromagnetic signal 104 continues to propagate toward the end of the probe 108. When the electromagnetic signal encounters the impedance discontinuity caused by the end of the probe 108, a reflection 106 returns to the gauge electronics unit 100 where an end-of-probe reflection is received.

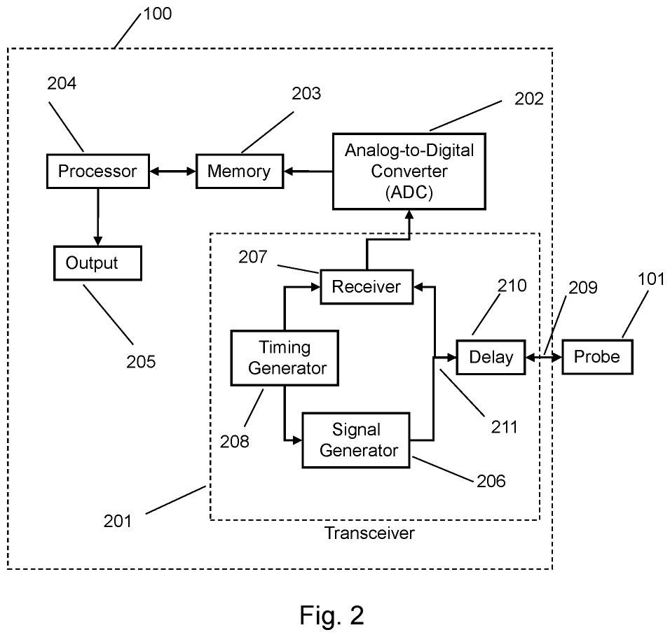

FIG. 2 illustrates an embodiment of a simplified block diagram of a level gauge system comprising the gauge electronics unit 100 and the probe 101. The gauge electronics unit further comprising: a transceiver 201 for generating, transmitting and receiving electromagnetic signals to and from the probe 101; an analog-to-digital converter (ADC) 202 for converting the output of a receiver 207 part of the transceiver 201 into digital values. Each sample output of the ADC 202 represents an increment in time as well as an increment in distance along the probe 101. The distance along the probe for each ADC sample output is determined by the timing generator 208, sample rate of the ADC and an electromagnetic signal velocity along the probe 101; a memory 203 for storing the output of the ADC 202, and storing values from a processor 204; the processor 204 for evaluating the received reflections and produce an output value for a level of a liquid 103 in the tank 102 of FIG. 1; and an output device 205 for sending the value of the level other system devices such as displays, motor controllers, valve controllers, programmable logic devices, computers, etc. The transceiver 201 further comprising: a signal generator 206 for generating a electromagnetic signal and transmitting them to the probe 101; a receiver 207 for receiving reflections from the probe 101; a timing generator 208 establishes the timing of the receiver sampling circuits relative to the signal generation in a manner that the receiver samples the received reflection signals along the probe and insure reflections are received over at least the entire length of the probe 101; and an optional delay 210 to separate, in time, a reflection caused by the probe 101 to the transceiver 201 electrical connection 209 from a direct feedthrough signal 211 from the output of the signal generator 206 to the input of the receiver 207.

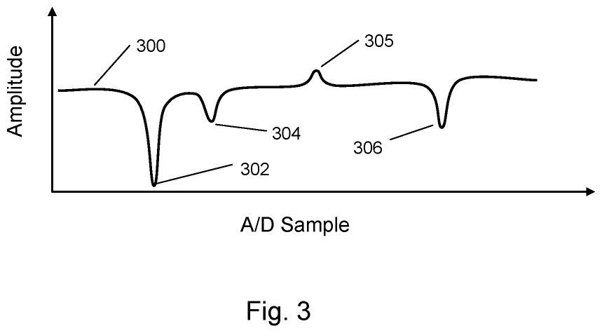

FIG. 3 illustrates the resulting reflection curve 300 for the first embodiment at the output of the ADC 202 of FIG. 2 for a partially filled tank 102. The direction of the peaks in reflection curve 300 can be either positive or negative going depending upon the polarity of the transmitted signal as well as the nature of an impedance discontinuity as discussed herein. A feedthrough peak 302 is caused by the direct path 211 in FIG. 2 from the signal generator 206 in FIG. 2 to the receiver 207 of FIG. 2. A probe-to-transceiver peak 304 is caused by a reflection created by an impedance discontinuity of the electrical connection 209 in FIG. 2 between the probe 101 in FIG. 2 and the transceiver 201 of FIG. 2 and herein referred to as a probe-to-transceiver peak. A surface peak 305 is caused by a reflection created by an impedance discontinuity at the surface 107 in FIG. 1 of the liquid 103 of FIG. 1 and herein referred to as a surface peak. In this example, the polarity of the surface peak is opposite the polarity of the feedthrough peak 302 because the signal is passing from higher impedance to lower impedance. An end-of-probe peak 306 is caused by a reflection 106 of FIG. 1 created by the end of the probe impedance discontinuity. The reflection curve 300 is stored in memory 203 in FIG. 2 as an array. The index pointer of the array is used to identify the time of a peak relative to the beginning of the array. The index pointer of the array is herein referred to as sample index.

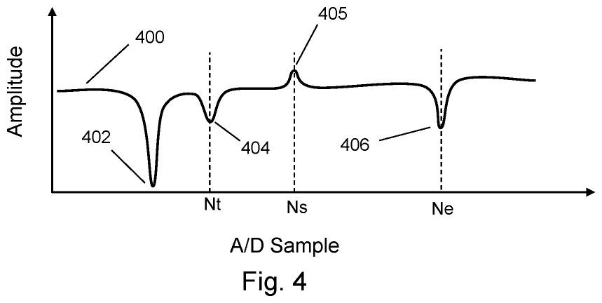

FIG. 4 illustrates a method of determining a level from the reflections received using a probe-to-transceiver peak 404, a surface peak 405 and an end-of-probe peak 406. FIG. 4 also illustrates the change in the signal velocity for the signal 104 in FIG. 1 as it travels along the probe 101 of FIG. 1 for a portion of the probe 101 of FIG. 1 above the surface 107 where the tank 102 in FIG. 1 contains atmosphere versus the signal velocity for the signal 104 in FIG. 1 as it travels along the probe 101 in FIG. 1 for a portion below the surface 107 in FIG. 1 where the tank contains liquid 103 in FIG. 1. In this example, the surface 107 in FIG. 1 is at the mid-point of the probe 101. Reflection curve 400 represents the output of the analog-to-digital converter 202 in FIG. 2. An end-of-probe peak 406 is located at a position marked Ne on curve 400. A surface peak 405 is located at a position marked as Ns. A probe-to-transceiver peak 404 is located at a position marked as Nt. The physical length of the probe, in this example, is the same for the portions above and below the surface 107 in FIG. 1. The electrical length of the portion of the probe above the material surface is the spacing between surface peak 405 and probe-to-transceiver peak 404 and as found by Ns-Nt. The electrical length of the portion of the probe below the surface 107 in FIG. 1 is the spacing between end-of-probe peak 406 and surface peak 405 and is found by Ne−Ns. The difference Ne−Ns is larger than the difference Ns−Nt confirming the signal velocity is slower below the surface 107 in FIG. 1 when compared to the signal velocity above the surface 107 in FIG. 1. A relative velocity (Vr) is the ratio of the signal velocity below the surface 107 in FIG. 1 to the signal velocity above the surface 107 in FIG. 1. In this example, where the physical length of the probe 101 is the same above and below the surface 107 in FIG. 1, the relative velocity is found by:

$$Vr = \frac{( Ns - Nt )}{( Ne - Ns )} , \qquad ( 1 )$$

where:

Vr is the relative velocity,
Ns is the sample index of the surface reflection,
Nt is the sample index of the probe-to-transceiver reflection,
Ne is the sample index of the end-of-probe reflection.

The relative velocity can be found for the general case of a partially filled tank 102 FIG. 1 by expressing the level as a fraction of the maximum fill by:

$$Vr = ( \frac{L}{1 - L} ) ( \frac{\vert Ns - Nt \vert}{Ne - Ns} ) , \qquad ( 2 )$$

where:

L is the fractional level of the material in the tank.

Conversely, be reorganizing the equation (2), the level can be determined by the follow:

$$L = \frac{Vr ( Ne - Ns )}{( Ns - Nt ) + Vr ( Ne - Ns )} \qquad ( 3 )$$

The example shows a level of a material in a tank can be found without knowing: the dimensions of the probe; the velocity of propagation; or the material properties. This enables a low skilled person to install and use the level gauge since no special knowledge is needed. It also suggests the probe can be simply cut to length without measuring or calibrating the gauge.

The probe-to-transceiver reflection 209 in FIG. 2 is used in some embodiments as a means to determine the timing of the surface reflection 105 in FIG. 1 and the end-of-probe reflection 106 in FIG. 1 relative to an electrical position of the top of the probe 101 in FIG. 1. As is, however, evident to a person skilled in the relevant art, an electrical position at or near the top of the probe can be established by other means such as: a fixed delay from the feedthrough signal 211 in FIG. 2, determined at the design time of the gauge; or by establishing a reflection along the probe 101 in FIG. 1. The use of the top of the probe connection reflection should by no means limit the scope of the present invention.

The use of equation (3) for determining the level assumes we know the relative velocity Vr. A typical value for Vr can be stored in a non-volatile memory, part of processor 204 in FIG. 2, at the time of manufacture of the gauge and used for a first level measurement after installation. A typical value for a RV storage tank is around 0.8 but can vary from 0.5 to 0.9 depending on the tank wall material and thickness as well as the probe construction.

The following discussion illustrates an embodiment of a method for determining the relative velocity Vr based on reflection curves from two different levels of material 103 FIG. 1 in the tank 101 FIG. 1. In summary, the method looks at how much the electrical length of the probe changes above the surface 107 in FIG. 1 relative to the change in electrical length below the surface 107 in FIG. 1 as the level of material 103 in FIG. 1 changes.

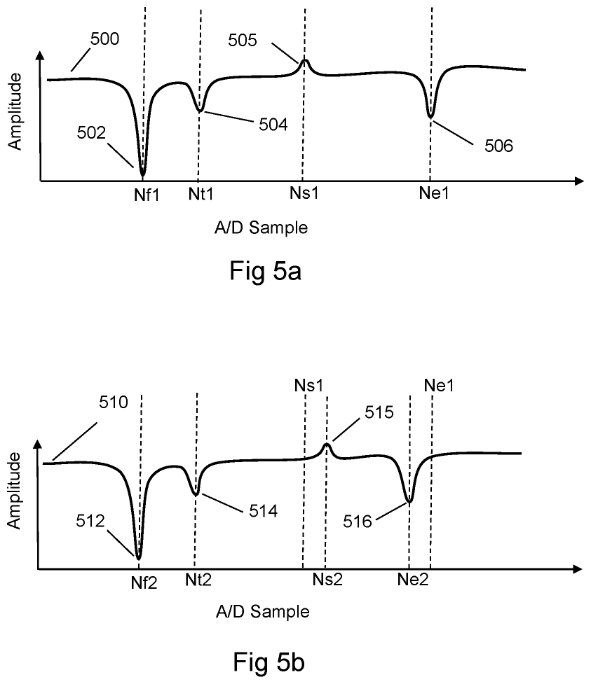

FIG. 5a and FIG. 5b illustrate the analog-to-digital converter 202 outputs for two different fill levels of a material 103 of FIG. 1 in the tank 102 of FIG. 1. In FIG. 5a a first level curve 500 is a result of a higher material surface level 103 in the tank 102 compared to a second level curve 510 in FIG. 5b which is a result of a lower material level surface 103 in the tank 102 of FIG. 1. In FIG. 5a, a probe-to-transceiver reflection 504 is marked at sample index Nt1. A surface peak 505 is marked at sample index Ns1. An end-of-probe peak 506 is marked at sample index Ne1. In FIG. 5b, a probe-to-transceiver peak 514 is marked at sample index Nt2. A surface peak 515 is marked at sample index Ns2. An end-of-probe peak 516 is marked at sample index Ne2. In this example, the first level is higher than the second level. It does not matter which level is higher as long as the two levels, first level and second level 2 are different. The electrical positions of Ns1 and Ne1 from FIG. 5a are shown in FIG. 5b to illustrate the movement of the peaks when the level changes.

In some embodiments, a method for measuring Vr and correcting the stored value of Vr is found by:

$$Vr = abs ( \frac{( ( Ns 2 - Nt 2 ) - ( Ns 1 - Nt 1 ) )}{( ( Ne 2 - Ns 2 ) - ( Ne 1 - Ns 1 ) )} ) , \qquad ( 4 )$$

where:

Ns1 is the sample index of the surface peak for the first level,
Nt1 is the sample index of the probe-to-transceiver peak for the first level,
Ne1 is the sample index of the end-of-probe peak for the first level,
Ns2 is the sample index of the surface peak for the second level,
Nt2 is the sample index of the probe-to-transceiver peak for the second level,
Ne2 is the sample index of the end-of-probe peak for the second level,
Vr is the relative velocity.

Thus the relative velocity Vr can be found by examining the received reflections without knowing: the dimensions of the probe 101 in FIG. 1; the velocity of propagation along the probe 101 in FIG. 1; or the properties of the material 103 in FIG. 1.

In many cases, the gauge 100 in FIG. 1 will be installed on an empty tank 102. This is particularly true when a manufacturer of a piece of equipment installs the gauge 100. At the time the gauge 100 is manufactured, the length of probe 101 may be made to a length that is longer than the tallest tank 102 the gauge 100 is specified to work on. Thus, when the power is applied to the gauge 100 after installation, where the probe 101 is cut to fit the dimensions of the tank 102, the processor 204 in FIG. 2 can recognize that the electrical length of the probe is shorter than the electrical length of probe when manufactured and can perform the following method to determine the relative velocity Vr.

In some embodiments, a method of determining the relative velocity Vr is to use the reflections when the tank is empty. In FIG. 5a, under the condition of an empty tank, a surface peak 505 is not present. The processor can find an electrical length of the probe by:

Le=Ne1−Nt1, (5)

where:

Nt1 is the sample index of the probe-to-transceiver peak for the first level,
Ne1 is the sample index of the end-of-probe peak for the first level,
Le is is the electrical length of the probe when the tank is empty.

As is, however, evident to a person skilled in the relevant art, the electrical length of the probe can be determined for a full tank by applying the relative velocity to the results of equation 5.

Referring to FIG. 5b, when the tank is partially filled to a second level, the relative velocity can be found by:

$$Vr = \frac{Le - ( Ns 2 - Nt 2 )}{( Ne 2 - Ns 2 )} , \qquad ( 6 )$$

where:

Le is the electrical length of the probe when the tank is empty,
Ns2 is the sample index of the surface peak for the second level,
Nt2 is the sample index of the probe-to-transceiver peak for the second level,
Ne2 is the sample index of the end-of-probe peak for the second level.

When the electrical length of the probe is known, the probe-to-transceiver peak 514, the end-of-probe peak 516, and relative velocity Vr is all that is needed to determine the level of liquid. In some embodiments, a method of determining the level of the liquid in the tank is to use: an end-of-probe peak; a probe-to-transceiver peak; an electrical length of the probe when empty (Le); and a relative velocity (Vr). This is useful when the peak from the surface reflection can not be reliably detected or identified separately from other peaks in the curve. The level can be found by:

$$Li = Ne - Nt , \qquad ( 7 )$$

$$Level ( \% ) = 100 \frac{( \frac{Le}{Vr} - Li )}{( \frac{Le}{Vr} - Le )} \qquad ( 8 )$$

where:

Nt is the sample index of the probe-to-transceiver reflection,
Ne is the sample index of the end-of-probe reflection,
Le is the previously determined electrical length of the probe,
Vr is the relative velocity,

Those skilled in the art will readily recognize that when the Level and Vr are known, Le can be determined by rearranging equation 8 and when the Level and Le are known, Vr can be determined by rearranging equation 8.

Under some conditions, it may be difficult to independently determine the location of the surface peak 515. Multiple reflections along the probe may cause peaks that compete with the surface peak and make detection and selection of the surface peak unreliable. In some embodiments, the result of the equation (8) may be used to determine the location of a surface peak 515 and can aid in the detection of the surface peak 515 for use in the level calculation equation (3) thus improving the reliability of the level measurement.

In some embodiments, the timing generator 208 of FIG. 2 is constructed of low cost, simple circuitry with little to no temperature compensation, reducing the material cost as well as other manufacturing costs such as testing and calibration. Timing changes cause the reflection curve 510 of FIG. 5b to expand or compress along the x-axis over time and temperature. Since the electrical position of all of the reflections change proportionally, the relative velocity Vr will remain unchanged, and these changes have no affect on level measurement accuracy when using equation (3). However, when using the electrical length of the probe Le as in equations (7) and (8), changes in timing may have an affect on accuracy since part of the data used is from a different time. While determining the value of Vr using equations (4) or (6), data is taken at different times, and changes in the timing may affect the accuracy of the relative velocity Vr. The solution is to use a reflection which has the property that the electrical position of the reflection's peak on the reflection curve is not influenced by the velocity of propagation along the probe but is influenced by the change in timing in the same manner as the other peaks on the curve are influenced.

In FIG. 2, a delay line 210 separates in time, the probe connection reflection 209 from the feedthrough signal 211. This produces space on the reflection curve 500 in FIG. 5a between the feedthrough peak 502 in FIG. 5a and the probe-to-transceiver peak 504 in FIG. 5a. Delay 210 in FIG. 2 is usually implemented by traces on a circuit board but may be implemented by various other methods such as lumped elements or coaxial cables. The amount of delay provided by delay 210 FIG. 2 need not be known. FIG. 5a illustrates the feedthrough peak 502 at sample index Nf1 and the probe-to-transceiver peak 504 at sample index Nt1. The electrical position of the probe-to-transceiver peak 504 relative to the electrical position of the feedthrough peak 502 is affected by changes in the timing in the same manner as the other peaks on the reflection curve. The reflection curve 510 in FIG. 5b in this example is taken at a different time than curve 500 in FIG. 5a. The amount of change caused by the timing changes can be determined by:

$$Cr = \frac{( Nt 2 - Nf 2 )}{( Nt 1 - Nf 1 )} , \qquad ( 9 )$$

where:

Nf1 is the sample index of the feedthrough peak for the first level,
Nt1 is the sample index of the probe-to-transceiver reflection for the first level,
Nf2 is the sample index of the feedthrough signal for the second level,
Nt2 is the sample index of the probe-to-transceiver reflection for the second level,
Cr is the correction ratio.

The affect of the timing change can be removed by multiplying the sample index of each peak used from the first level by Cr prior to use in combination with the sample index of the peaks of the second level to determine Vr or the level.

In some applications, it may be more convenient to mount the gauge electronics near the bottom of the tank rather than near the top of the tank. Other factors such as the impedance match of the probe to the gauge electronics may influence the decision to mount the gauge near the bottom of the tank.

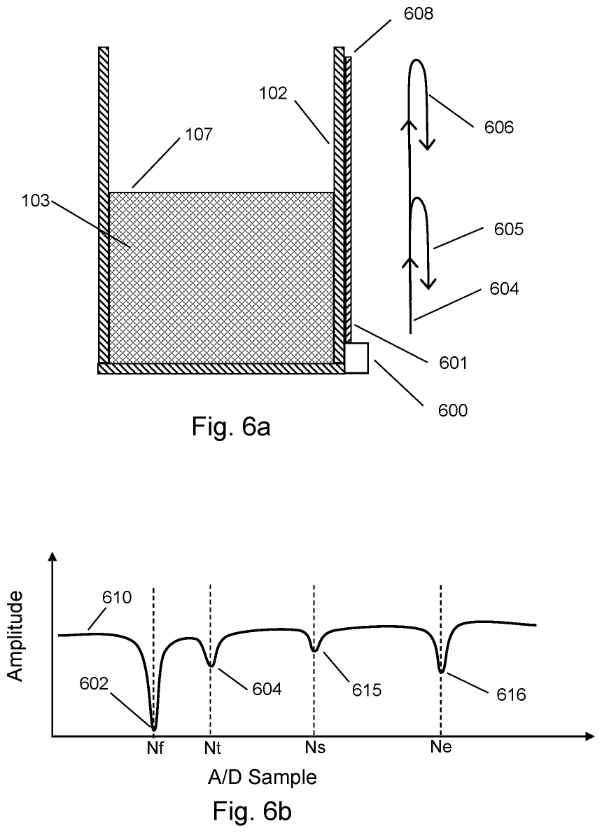

In some embodiments, FIG. 6a illustrates a gauge electronics unit 600 connected to the lowest point of a probe 601. The probe 601 is in contact with the outside surface of a tank 102. The tank 102 is partially filled with a material 103 having a surface 107. The probe 601 propagates a signal 604 as illustrated from the gauge electronics unit 600 upward along the probe toward the end of the probe 608. When the signal encounters an impedance discontinuity caused by the surface 107, a reflection 605 is returned to the gauge 600 where the surface reflection is received. A portion of the signal 604 continues to propagate toward the end of the probe 608. When the signal encounters the impedance discontinuity caused by the end of the probe 608, a reflection 606 returns to the gauge electronics unit 600 where an end-of-probe reflection is received.

FIG. 6b illustrates the resulting curve 610 at the output of the analog-to-digital converter 202 of FIG. 2 for a partially filled tank 102 FIG. 6a. The direction of the peaks in reflection curve 610 can be either positive or negative going depending upon the polarity of the transmitted signal as well as the nature of the impedance discontinuity as discussed herein. A feedthrough peak 602, a probe-to-transceiver peak 604, a surface peak 615 and an end-of-probe peak 616 are produced by the impedance discontinuities encountered by the signal propagating along the probe 601. The polarity of the surface peak 615 is the same as the polarity of the feedthrough peak 602 because the signal 604 is passing from lower impedance to higher impedance. The signal begins propagating along the probe 601 below the material surface 107 and therefore Vr is now applied to the timing between the probe-to-transceiver peak 604 and the surface peak 615 rather that between the surface peak 615 and the end-of-probe peak 616.

The equations for level and Vr are developed in the same manner as in the top mounted gauge electronics illustrations and are:

$$L = \frac{( Ne - Ns )}{Vr ( Ns - Nt ) + ( Ne - Ns )} , \qquad ( 10 )$$

$$Vr = abs ( \frac{( ( Ne 2 - Ns 2 ) - ( Ne 1 - Ns 1 )}{( ( Ns 2 - Nt 2 ) - ( Ns 1 - Nt 1 ) )} ) , \qquad ( 11 )$$

$$Vr = \frac{Le - ( Ne 2 - Ns 2 )}{( Ns 2 - Nt 2 )} , \qquad ( 12 )$$

where:

Ns1 is the sample index of the surface peak for the first level,
Nt1 is the sample index of the probe-to-transceiver peak for the first level,
Ne1 is the sample index of the end-of-probe peak for the first level,
Ns2 is the sample index of the surface peak for the second level,
Nt2 is the sample index of the probe-to-transceiver peak for the second level,
Ne2 is the sample index of the end-of-probe peak for the second level,
Le is the electrical length of the probe,
Vr is the relative velocity.

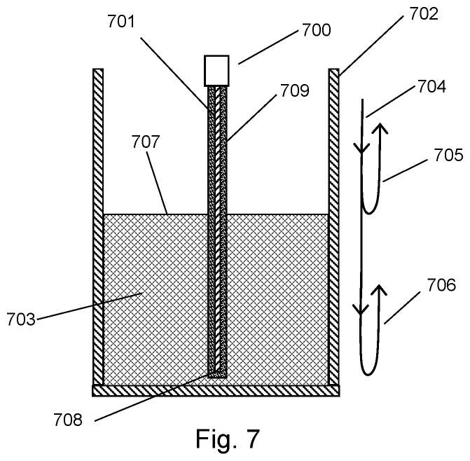

In some embodiments, FIG. 7 illustrates a gauge electronics unit 700 connected to a probe 701. The probe 701 is directed toward the surface 707 of a material 703 contained in a tank 702. The probe is partially immersed in the material. The probe 701 is isolated from the material 703 by a jacket of non-conductive material 709. The probe 701 propagates a signal 704 as illustrated from the gauge electronics unit 700 along the probe toward the end of the probe 708. When the signal encounters an impedance discontinuity caused by the surface 707, a surface reflection 705 is returned to the gauge 700 where a surface reflection is received. A portion of the signal 704 continues to propagate toward the end of the probe 708. When the signal encounters the impedance discontinuity caused by the end of the probe 708, a reflection 706 returns to the gauge electronics unit 700 where an end-of-probe reflection is received. When a probe 701 without a jacket 709 is immersed in a high dielectric material 703 such as water or water-based chemicals, the surface reflection 705 is large in amplitude and little, if any, of the signal continues to propagate toward the end of the probe 708, and the reflection resulting from the reflection 706 is not detectable by the gauge electronics 700. The jacket 709 is configured to reduce the surface reflection 705 and increase the end of probe reflection 706. The jacket 709 material can be, but not limited to, plastic, rubber, resin, glass, and air. The thickness of the jacket varies with probe configuration and the dielectric of the material 703. For low dielectric materials such as petroleum products, oils, and plastic pellets the thickness of the jacket 709 can be zero. For high dielectric materials 703, the thickness of the jacket 709 may reach 1 inch. The probe 701 may be a wire, rod, cable or twin lead. For a twin lead configuration, the jacket 709 may also fill the space between the conductors to further reduce the surface reflection 705. The received reflections from the probe connection point 209 in FIG. 2, material surface 707, and end of probe 708 are processed with the same methods described herein.

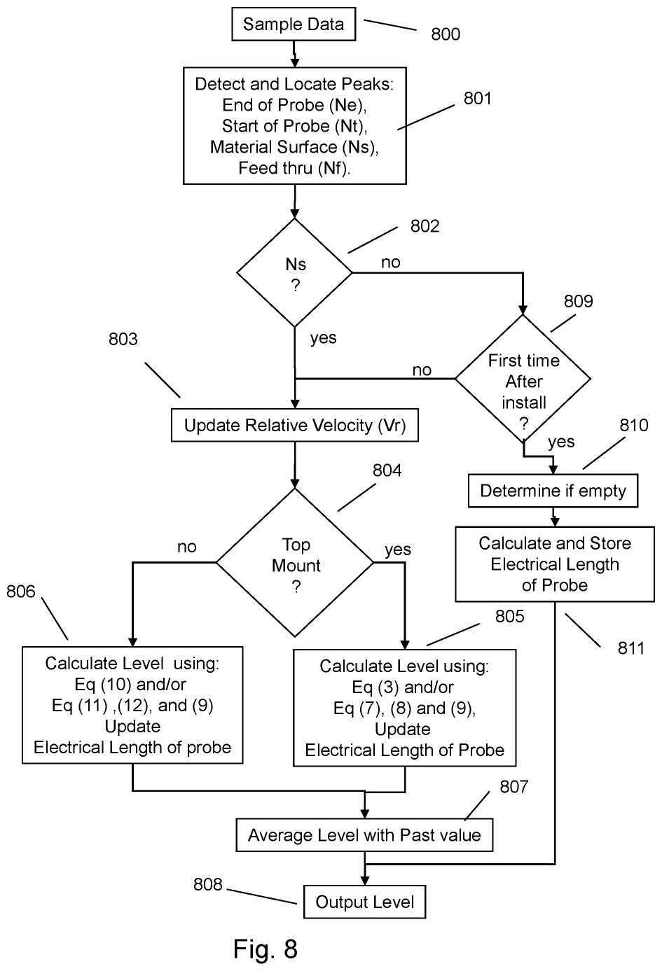

A flow-chart for an embodiment of a method for determining a level of material in tank is described in FIG. 8. In the first block 800, the transceiver 201 in FIG. 2 generates, transmits, and receives signals; the analog-to-digital converter 202 in FIG. 2 samples and stores received reflections in memory 203 in FIG. 2 as an array. In block 801, the processor 204 of FIG. 2 scans the array and detects peaks based on the location in the array, magnitude, polarity, and shape of the peaks. The sample index of each peak is assigned to variables Ne, Nt, Ns, and Nf. The resolution of the sample index may be enhanced by curve fitting the data around the peak value. Decision block 802 determines if the surface reflection peak Ns was detected, if it is detected the relative velocity Vr can be calculated in block 803. If the surface reflection peak Ns was not detected, block 809 determines if this is the first time after installation on the tank 102 in FIG. 1 that the gauge 100 in FIG. 1 has been turned on. Block 809 examines the end-of-probe peak Ne to determine if it has shifted in position since manufacturing tests were performed. Block 809 may also test variables such as the relative velocity Vr to determine if they have changed since manufacturing. If the present case is not the first time after installation, then the update relative velocity Vr, block 803 is performed. If this is the first time after installation block 810 examines position and amplitude of the probe-to-transceiver peak Nt and the end-of-probe peak Ne to determine if the tank is empty and sets the level to empty for output by block 808. Block 811 then calculates the electrical length Le of the probe based on Ns, Ne, and Vr and stores it for later use. After block 803 determines an updated relative velocity Vr, decision block 804 is performed. Block 804 examines the polarity of the surface reflection peak Ns if available or the amplitude of the probe-to-transceiver peak Nt to determine if the gauge electronics 100 in FIG. 1 is attached to the top or bottom of the probe 101. Based on the decision of block 804, either block 805 or block 806 is used to calculate the level and update the electrical length of probe Le. Block 807 averages the new level value with a past level value and sends the result to 808. Block 808 sends the data out of the gauge to other system components. The output path can be either hardwired or wireless.

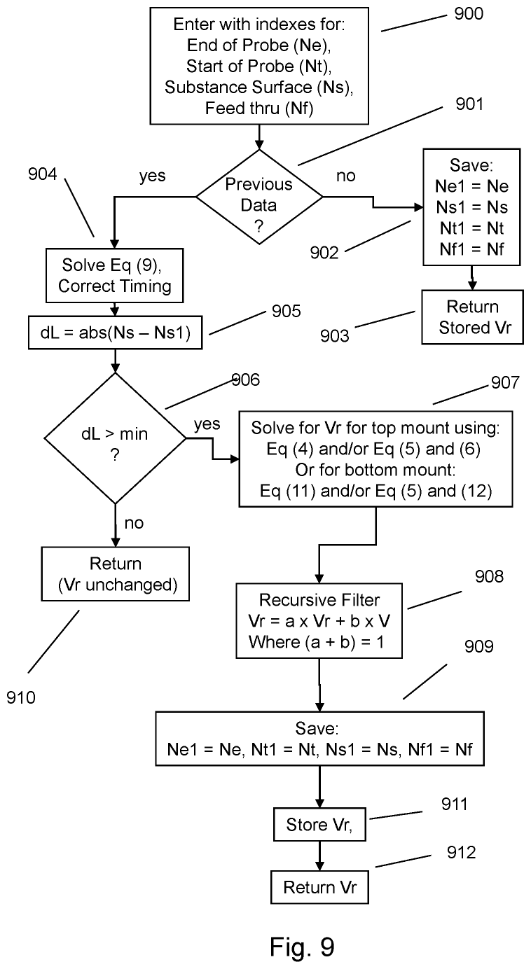

A flow-chart of an embodiment of a method for determining the relative velocity (Vr) of propagation along the probe 101 in FIG. 1 for portions of the probe that is above the material surface 107 in FIG. 1 relative to the velocity of propagation along the probe 101 in FIG. 1 for the portion of the probe 101 that is below the material surface 107 in FIG. 1 is described in FIG. 9. Block 900 represents the entry point for this method and shows the required data. Block 901 examines memory 203 in FIG. 2 to determine if data exist from a prior level measurement by looking at variables Ne1, Ns1, Nf1, and Nt1. If these variables are not valid, then the current variables are stored in their place and the method returns without updating Vr. If previous data is found, then block 904 is performed. Block 904 corrects the stored values of Ne1, Ns1, Nt1, and Nf1 for timing differences that may exist using Equation (9). Block 905 measures the change in the surface reflection sample index between the corrected stored values and the current values. Block 906 tests the change from block 905 to determine if the level has changed enough to overcome sampling errors and noise to be able to perform a valid relative velocity calculation. Depending on the implementation of the electronics and configuration of the probe, the minimum would vary from 5% to 10% of the value (Ne-Nt). If the condition set forth in block 906 is not met, the method returns without updating Vr. If the condition is met, block 907 is performed where Vr is calculated. The resulting Vr value is then combined with a previous value of Vr with a recursive filter. The values of a and b in the equation can be varied to weight the new value of Vr heavier or less based on factors such as: how long the gauge has been on since power applied, how different the new value is from the old value, and any quality factors for the peaks that may be determined during peak detection. Block 909 replaces the saved values of peaks with the new values. Block 911 stores the new Vr in non-volatile memory. Block 912 returns the new value of Vr.

Those skilled in the art will readily recognize that some methods may be eliminated and not performed or performed in a different sequence. One example: if for a particular installation, the relative velocity is determined by test or analysis and not expected to change over time it may be stored in the gauge at time of manufacturing, and the update relative velocity methods may be eliminated. Another example: if the electrical length of the probe is determined by test or analysis, it may be stored in the gauge at time of manufacturing and the calculate and store electrical length of probe method may be eliminated. Another example is if the accuracy requirements for the level are low, then either or both methods may be eliminated.

The various embodiments described above are provided by way of illustration only and should not be construed to limit the scope. Those skilled in the art will readily recognize various modifications and changes that may be made without following the example embodiments and applications illustrated and described herein, and without departing from the true spirit and scope.

1. A system for measuring a level of a material contained in a tank, the system comprising:
a transceiver for generating, transmitting and receiving electromagnetic signals;
a probe electrically connected to said transceiver configured to extend towards and beyond a surface of said material in said tank for guiding said transmitted electromagnetic signals toward the surface of the material, and guiding reflections from impedance transitions encountered by the transmitted electromagnetic signals back to the transceiver; and
a processor configured to:
determine a time of reception at said transceiver relative to a transmission time of said transmitted electromagnetic signals of a first set of reflections including at least a first end-of-probe reflection from the impedance transition at the end of said probe and a first probe-to-transceiver reflection from the impedance transition of a connection of said probe to said transceiver;
determine a first level of said material in said tank based on the time of reception of said first end-of-probe reflection, the time of reception of said first probe-to-transceiver reflection, an electrical length of the probe, and a relative velocity based on a velocity of propagation of said electromagnetic signals in the portion of said probe above said surface of said material and a velocity of propagation of the electromagnetic signals in the portion of the probe below the surface of the material.

2. The system according to claim 1 wherein said tank is constructed of a non-metallic substance, said probe is attached to an outside surface of the tank and the probe is oriented in a generally vertical direction wherein said electromagnetic signals are propagated downward toward said surface of said material.

3. The system according to claim 1 wherein said tank is constructed of a non-metallic substance, said probe is attached to an outside surface of the tank and the probe is oriented in a generally vertical direction wherein said electromagnetic signals are propagated upward toward said surface of said material.

4. The system according to claim 1 wherein said probe is enveloped in a jacket wherein the jacket and the probe are configured to improve amplitude of said end-of-probe reflection.

5. The system according to claim 1 where a time of reception of a first surface reflection is determined based on said first level of material, said relative velocity, said time of reception of said first end-of-probe reflection, and said time of reception of said first probe-to-transceiver reflection.

6. The system according to claim 5, wherein said processor is further configured to:
determine said relative velocity based on at least a second set of reflections that include at least a second time of reception of an end-of-probe reflection, a second time of reception of a surface reflection, and a second time of reception of a probe-to-transceiver reflection, wherein the second set of reflections is determined when a second level of said material in said tank is different from said first level of material in the tank when the first set of reflections was determined; and
store the relative velocity in a non-volatile memory.

7. The system according to claim 6 where at least one of said sets of reflections used to determine said relative velocity is further modified based on a time of reception of a feedthrough signal directly from a transmitting side of said transceiver to a receiving side of the transceiver wherein the system is further configured with a fixed delay line that separates, in time, a first feedthrough signal from said first probe-to-transceiver reflection and a second feedthrough signal from said second probe-to-transceiver reflection.

8. A system for measuring a level of a material contained in a tank, the system comprising:
a transceiver for generating, transmitting and receiving electromagnetic signals;
a probe electrically connected to said transceiver configured to extend towards and beyond a surface of said material in said tank for guiding said transmitted electromagnetic signals toward a surface of said material, and guiding reflections from impedance transitions encountered by the transmitted electromagnetic signals back to the transceiver; and
a processor configured to:
determine a time of reception at said transceiver relative to a transmission time of said transmitted electromagnetic signals of a first set of reflections including at least a first end-of-probe reflection from the impedance transition at the end of said probe, a first surface reflection from the impedance transition of a surface of said material, and a first probe-to-transceiver reflection from the impedance transition of a connection of said probe to said transceiver;
determine a first level of said material in said tank based on the time of reception of said first end-of-probe reflection, the time of reception of said first probe-to-transceiver reflection, the time of reception of said first surface reflection from the impedance transition of the surface of the material, and a relative velocity based on a velocity of propagation of said electromagnetic signals in the portion of said probe above said surface of said material and a velocity of propagation of the electromagnetic signal in the portion of the probe below the surface of the material.

9. The system of claim 8 the processor further configured to:
determine said relative velocity based on at least a second set of reflections that include at least the time of reception of a second end-of-probe reflection, the time of reception of a second surface reflection, and the time of reception of a second probe-to-transceiver reflection, wherein said second set of reflections is determined when a second level of said material in said tank is different from said first level of material in the tank when said first set of reflections was determined; and
store the relative velocity in a non-volatile memory.

10. The system according to claim 9 where at least one of said sets of reflections used to determine said relative velocity is further modified based on a time of reception of a feedthrough signal directly from a transmitting side of said transceiver to a receiving side of the transceiver wherein the system is further configured with a fixed delay line that separates, in time, a first feedthrough signal from said first probe-to-transceiver reflection and a second feedthrough signal from said second probe-to-transceiver reflection.

11. The system of claim 8 said processor further configured to:
determine said electrical length of said probe based on the time of reception of said first end-of-probe reflection, the time of reception of said first probe-to-transceiver reflection, the time of reception of said first surface reflection, and said relative velocity; and
store the electrical length in a non-volatile memory.

12. The system of claim 8 said processor further configured to determine whether said electromagnetic signal is propagating downward towards said surface of said material or upward toward the surface based the polarity of said first surface reflection.

13. A method of determining a level of a material contained in a tank, the method comprising:
generating and transmitting electromagnetic signals;
propagating the electromagnetic signals toward a surface of said material contained in said tank along a probe extending towards and beyond a surface of the material contained in the tank;
receiving a first-set of reflections resulting from reflections at impedance transitions encountered by the transmitted electromagnetic signals along the probe, including at least a first connection reflection resulting from a reflection caused by a connection of the probe to an electronic circuit that generates, transmits and receives said electromagnetic signals, a first surface reflection resulting from a reflection at a surface of said material, a first end-of-probe reflection resulting from a reflection at a end of the probe, and a first feedthrough signal resulting from an intersection of a transmitter side of said electronic circuit and a receiving side of said electronic circuit;
determining if said surface reflection is detectable based on the first-set of reflections;
if said surface reflection is detectable, determining an update first level and a update electrical length of said probe based on the first-set of reflections and a relative velocity based on a velocity of propagation of said electromagnetic signals in the portion of said probe above said surface of said material and a velocity of propagation of the electromagnetic signals in the portion of the probe below the surface of the material;
if said surface reflection is not detectable, determining if the first-set of reflections is the first reflections received after said probe has been installed on said tank based on the first end-of-probe reflection;
if the first-set of reflections is the first reflections received after installation, determining an electrical length of said probe based on said first connection reflection and said first end-of-probe reflection; and
if the first-set of reflections is not the first reflections received after installation, determining an update first level based on said first connection reflection, said first end-of-probe reflection, and said electrical length of said probe, and said relative velocity.

14. The method of claim 13 further comprising of:
receiving at least a second-set of reflections resulting from reflections at impedance transitions encountered by the transmitted electromagnetic signals, including at least a second connection reflection resulting from a reflection caused by a connection of said probe to said electronic circuit, a second surface reflection resulting from a reflection at said surface of said material, a second end-of-probe reflection resulting from a reflection at the end of said probe and a second feedthrough signal resulting from said intersection of said transmitter side of said electronic circuit and said receiving side of said electronic circuit;
determining an update of said relative velocity based on said first-set of reflections and said second-set of reflections.

15. The method according to claim 14 where at least one of said sets of reflections used to determine said relative velocity is further modified based on a time of reception of said first feedthrough signal, said first connection reflection, said second feedthrough signal, and said second connection reflection.

16. The method of claim 13 further comprising of determining if said electromagnetic signals are propagating downward toward said surface of said material or upward toward the surface of the material based on the first surface reflection.
